(19) United States
(12) Patent Application Publication
(10) Pub. No.: US 2023/0416432 A1
(43) Pub. Date: Dec. 28, 2023

(54) INFRARED ABSORBENT DISPERSION, TRANSPARENT HEAT-INSULATING ORGANIC GLASS, AND MANUFACTURING METHOD THEREOF

(71) Applicant: ZHEJIANG HUASHUAITE NEW MATERIAL TECHNOLOGY CO., LTD., Jiaxing City, Zhejiang Province (CN)

(72) Inventors: JIEHAO QU, Jiaxing City, Zhejiang Province (CN); SHENGJIONG YIN, Jiaxing City, Zhejiang Province (CN); QINQIN FAN, Jiaxing City, Zhejiang Province (CN); WANGJIE XU, Jiaxing City, Zhejiang Province (CN)

(21) Appl. No.: 18/038,005

(22) PCT Filed: Mar. 28, 2022
(86) PCT No.: PCT/CN2022/083519

§ 371 Date: May 20, 2023

(30) Foreign Application Priority Data
Mar. 30, 2021 (CN) 202110338268.6

(51) Int. Cl. C08F 220/14; C08F 2/44; C08K 3/22; C08L 33/12

(52) U.S. Cl. CPC C08F 220/14; C08F 2/44; C08K 3/22; C08L 33/12; C08K 2201/005; C08L 2201/10; C08L 2205/22

(57) ABSTRACT

A dispersant of an infrared absorbent dispersion is distributed in an outer layer of an infrared absorbent to form an independent unit dispersed in an organic solvent; the molecular structure of the dispersing agent has an active unit capable of undergoing a free radical copolymerization reaction with a methyl methacrylate monomer and/or a group capable of generating intermolecular forces with polymethyl methacrylate; and the organic solvent can be mutually soluble with the methyl methacrylate monomer and the polymethyl methacrylate. Due to the stable dispersion and suspension of the infrared absorbent in a dispersion and the high inter-miscibility and adaptability of the dispersion and the matrix material, the infrared absorbent is evenly dispersed in the organic glass. The infrared absorbent is tightly bound to the matrix via the dispersant on the outer layer, such that the organic glass is uniformly transparent under visible light and can uniformly block infrared light.

### CROSS-REFERENCE TO RELATED APPLICATION

The present application claims the priority of a Chinese patent application No. 202110338268.6, filed Mar. 30, 2021, applicant of “ZHEJIANG HUASHUAITE NEW MATERIAL TECHNOLOGY CO., LTD”, titled of “INFRARED ABSORBENT DISPERSION, TRANSPARENT HEAT-INSULATING ORGANIC GLASS, AND MANUFACTURING METHOD THEREOF”, the entire content of which is incorporated herein by reference.

### TECHNICAL FIELD

The present application relates to the technical field of transparent heat-insulating material, and in particular to an infrared absorbent dispersion, a transparent heat-insulating organic glass, and a manufacturing method thereof.

### BACKGROUND

Most of the solar radiation energy is distributed in visible light and infrared light, and the rest is ultraviolet light, in which the infrared light is the main source of thermal effect. As a polymer additive, infrared absorbent has important application value in the fields of optical materials, laser protection, building heat insulation, and near infrared stealth, etc., as it meets a special function of heat insulation and moderate light transmittance, which becomes a kind of advanced functional additive developed in recent years. As a key member of transparent materials, organic glass is expected to obtain specific applications in the field of transparent heat insulation to inhibit temperature rise on the basis of fully meeting transparency. Taking plant cultivation as an example, it's desired for the researchers to achieve effective heat shielding without affecting the visible light transmission required by plant growth. However, the existing infrared absorbent are mainly inorganic powders, it is difficult to carry out homogeneous dispersion and stable and tight interface bonding in the intrinsic oil system of the organic glass, which affects the total efficiency of heat insulation, light transmission uniformity, and product appearance. These interference problems become more obvious for the preparation of the organic glass in pouring process.

The foregoing description is intended to provide general background and does not necessarily constitute prior art.

### Technical Problem

The existing infrared absorbent are mainly inorganic powders, it is difficult to carry out homogeneous dispersion and stable and tight interface bonding in the intrinsic oil system of the organic glass, which affects the total efficiency of heat insulation, light transmission uniformity, and product appearance. These interference problems become more obvious for the preparation of the organic glass in pouring process.

### Technical Solution

In view of the above technical problems, the present application provides an infrared absorbent dispersion, a transparent heat-insulating organic glass, and a manufacturing method thereof, which can effectively endow with organic glass uniform transparency of visible light and uniform blocking effect of infrared light.

To solve the above technical problems, the present application provides an infrared absorbent dispersion including an infrared absorbent, a dispersant and an organic solvent, wherein the dispersant is distributed in an outer layer of the infrared absorbent to form an independent unit dispersed in the organic solvent; molecular structure of the dispersant contains an active unit capable of generating a free radical copolymerization reaction with a methyl methacrylate monomer and/or a group capable of generating intermolecular forces with polymethyl methacrylate; and the organic solvent is an organic solvent that is mutually soluble with the methyl methacrylate monomer and the polymethyl methacrylate.

Optionally, a mass proportion of the infrared absorbent is 10%-60%, a mass proportion of the dispersant is less than or equal to 5%, and a mass proportion of the organic solvent is more than or equal to 30%.

Optionally, the infrared absorbent is inorganic powder particles comprising one or more of WO₃, MoO₃, ATO, ITO, BTO, GTO and CsxWO₃, with a particle size range of 5-100 nm.

Optionally, the dispersant is one or more of silicone modified acrylate, polyester modified dimethylsiloxane containing hydroxy functional groups, polyether modified polydimethylsiloxane, low molecular weight unsaturated acid polycarboxylate polyester containing polysiloxane copolymers, organic salts, esters, amides, polyoxyethylene, alkyl and/or sulfobetaine, and alkyl and/or hydroxy-oxyamine; and/or, the organic solvent is at least one of hydrocarbon solvent, ester solvent, ketone solvent, alcohol solvent, ether solvent, and alcohol ether solvent, chloroform, tetrahydrofuran, dichloromethane, trichloromethane, dichloroethane, and dioxane.

The present application further provides a manufacturing method of a transparent heat-insulating organic glass, including:
a. providing a matrix material and the infrared absorbent dispersion as mentioned above;
b. preparing a homogeneous mixture containing the matrix material, the infrared absorbent dispersion and an initiator;
c. curing the homogeneous mixture so that the matrix material is polymerized to form a matrix, and the infrared absorbent is distributed in the matrix by free radical copolymerization reactions and/or intermolecular forces between the dispersant located at the outer layer and the matrix material;
d. obtaining a transparent heat-insulating organic glass.

Optionally, step a includes:
polymerizing methyl methacrylate to form a precursor mixture containing partial polymerized precursors to obtain the matrix material; or
preparing polymethyl methacrylate resin particles into a precursor mixture with methyl methacrylate as solvent to obtain the matrix material.

Optionally, in the precursor mixture containing partial polymerized precursors, a conversion rate of the methyl methacrylate is 10%-50%; or when preparing the precursor mixture with methyl methacrylate as solvent, a mass proportion of the polymethyl methacrylate resin particles is 5%-50%.

Optionally, step a includes:
providing the infrared absorbent, the dispersant and the organic solvent;
mixing the infrared absorbent, the dispersant and the organic solvent at a speed of less than or equal to 500 rpm for 1-5 min to obtain a premix;
treating the premix by Nano dispersion technology and then filtering, to obtain the infrared absorbent dispersion.

Optionally, in step b, a mass proportion of the infrared absorbent dispersion is less than or equal to 5%, a mass proportion of the matrix material is more than or equal to 90%, and a mass proportion of the initiator is less than or equal to 0.5%, and the initiator comprises one or more of BPO, AIBN and ABVN.

The present application further provides a transparent heat-insulating organic glass, manufactured by the manufacturing method of a transparent heat-insulating organic glass as mentioned above.

For the infrared absorbent dispersion of the present application, the dispersant is distributed in the outer layer of the infrared absorbent to form an independent unit dispersed in the organic solvent, and the molecular structure of the dispersant has an active unit capable of generating a free radical copolymerization reaction with a methyl methacrylate monomer and/or a group capable of generating intermolecular forces with polymethyl methacrylate. In the manufacturing method of a transparent heat-insulating organic glass of the present application, the infrared absorbent is distributed in the matrix by free radical copolymerization reactions and/or intermolecular forces between the dispersant located at the outer layer and the matrix material. Due to stable suspension of the infrared absorbent in the dispersion and high intermiscibility and compatibility between the dispersion and the matrix material, the dispersion uniformity of the infrared absorbent in the organic glass is improved. At the same time, by free radical copolymerization reactions and/or intermolecular forces between the dispersant located at the outer layer and the matrix material, the infrared absorbent is distributed in the matrix and tightly bonded with the matrix, which endows with organic glass uniform transparency of visible light and uniform blocking effect of infrared light. Further, the organic glass may be prepared by traditional pouring and curing process with low cost.

### Technical Effects

For the infrared absorbent dispersion of the present application, the dispersant is distributed in the outer layer of the infrared absorbent to form an independent unit dispersed in the organic solvent, and the molecular structure of the dispersant has an active unit capable of generating a free radical copolymerization reaction with a methyl methacrylate monomer and/or a group capable of generating intermolecular forces with polymethyl methacrylate. In the manufacturing method of a transparent heat-insulating organic glass of the present application, the infrared absorbent is distributed in the matrix by free radical copolymerization reactions and/or intermolecular forces between the dispersant located at the outer layer and the matrix material. Due to stable suspension of the infrared absorbent in the dispersion and high intermiscibility and compatibility between the dispersion and the matrix material, the dispersion uniformity of the infrared absorbent in the organic glass is improved. At the same time, by free radical copolymerization reactions and/or intermolecular forces between the dispersant located at the outer layer and the matrix material, the infrared absorbent is distributed in the matrix and tightly bonded with the matrix, which endows with organic glass uniform transparency of visible light and uniform blocking effect of infrared light. Further, the organic glass may be prepared by traditional pouring and curing process with low cost.

### BRIEF DESCRIPTION OF THE DRAWINGS

FIG. 1 is a schematic diagram showing the composition of an infrared absorbent dispersion according to a first embodiment.

FIG. 2 is a flowchart of a manufacturing method of a transparent heat-insulating organic glass according to a second embodiment.

FIG. 3 is a schematic diagram showing the composition of the transparent heat-insulating organic glass according to the second embodiment.

FIG. 4 shows the performance comparison data between Processes 1-3 according to the second embodiment and the control group.

### DETAILED DESCRIPTION OF ILLUSTRATED EMBODIMENTS

The implementation of the present application will be described by specific embodiments as follows. Persons skilled in the art can easily understand other advantages and effects of the present application from the contents disclosed in this disclosure.

In the following description, several embodiments of the present application are described with reference to the attached drawings. It should be understood that other embodiments may be used, and changes on the mechanical components, structure, electrical and operational may be made without deviating from the spirit and scope of the present application. The detailed description below should not be construed as restrictive, and the terms used herein are only intended to describe the specific embodiments and not to restrict the present application.

Although the terms “first” or “second” and the like are used to describe various components in some embodiments of the present disclosure, the components should not be restricted by these terms, which are only to distinguish one component from another,

Furthermore, as used in the present disclosure, the singular forms “a”, “an”, “one” and “the” are intended to include the plural forms as well, unless the context indicates otherwise. It should be further understood that the terms “include”, “comprise” indicate the presence of the features, steps, operations, elements, components, items, kinds, and/or groups, but do not exclude the existence, occurrence, or addition of one or more other features, steps, operations, elements, components, items, kinds, and/or groups. The terms “or” and “and/or” used herein are construed as inclusive, or to mean any one or any combination. Thus, “A, B or C” or “A, B and/or C” means “any of the following: A; B; C; A and B; A and C; B and C; and A, B and C”. An exception to this definition occurs only when combinations of components, functions, steps, or operations are inherently mutually exclusive in some way.

### First Embodiment

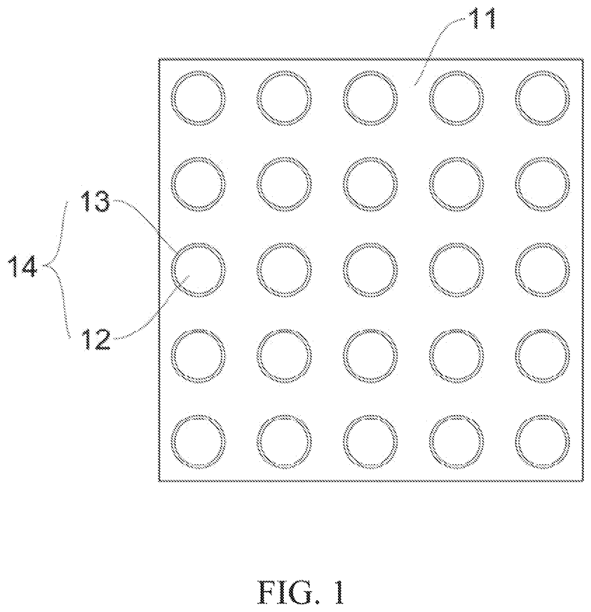

FIG. 1 is a schematic diagram of the composition of the infrared absorbent dispersion according to the first embodiment. As shown in FIG. 1, the infrared absorbent dispersion in the present embodiment includes an infrared absorbent 12, a dispersant 13 and an organic solvent 11. The dispersant 13 is distributed in an outer layer of the infrared absorbent 12 to form an independent unit 14 dispersed in the organic solvent 11.

The infrared absorbent 12 is inorganic powder particles, including one or more of WO₃, MoO₃, ATO, ITO, BTO, GTO, CsxWO₃, with a particle size range of 5-100 nm. Specifically, ATO is tin antimony oxide, ITO is indium tin oxide, BTO is bismuth tin oxide, GTO is tungsten-vanadium tin antimony oxide and CsxWO₃ is cesium-tungsten bronze.

The dispersant 13 is an oil-soluble interfacial agent. The molecular structure of dispersant 13 contains an active unit that can generate free radical copolymerization reactions with methyl methacrylate monomer and/or a group that can generate intermolecular force with polymethyl methacrylate. Specifically, the active unit is one of ethylenic bond and silico-hydrogen bond. The group is one of polybutyl acrylate chain segment, polymethacrylate ethyl ester chain segment, polymethyl phenyl siloxane chain segment, poly ethyl acrylate chain segment, polystyrene chain segment, polyvinyl chloride chain segment, bisphenol A polycarbonate chain segment, polymethyl methacrylate chain segment, polymethyl acrylate chain segment, polybutyl methacrylate chain segment, polypropyl methacrylate chain segment, polyvinyl acetate chain segment, epoxy resin chain segment, polysulfide rubber chain segment, polybutadiene chain segment, polychloroprene chain segment, cellulose nitrate chain segment, polybutadiene-acrylonitrile chain segment, and polybutadiene-styrene chain segment. The dispersant 13 is distributed in the outer layer of the infrared absorbent 12, so as to prevent the sedimentation and agglutination of the infrared absorbent 12 and form a stable suspension based on the double electric layer theory and steric hindrance effect.

Optionally, the dispersant 13 is one or more of silicone modified acrylate, polyester modified dimethylsiloxane containing hydroxy functional groups, polyether modified polydimethylsiloxane, low molecular weight unsaturated acid polycarboxylate polyester containing polysiloxane copolymers, organic salts, esters, amides, polyoxyethylene, alkyl and/or sulfobetaine, and alkyl and/or hydroxy-oxyamine. Specifically, the organic salts include alkyl phosphate mono/bi ester salt, fatty alcohol polyoxyethylene ether and its phosphate mono/bi ester salt, alkyl phenol polyoxyethylene ether and its phosphate mono/bi ester salt, primary alkyl sulfate salt, secondary alkyl sulfate salt, alkyl benzene sulfonate, α-olefin sulfonate, alkyl sulfonate, succinate sulfonate, alkyl naphthalene sulfonate, petroleum sulfonate, lignosulfonate, alkyl naphthalene sulfonate, potassium/sodium/ammonium salt of advanced fatty acids, amine salt, or quaternary ammonium salt. The esters include α-sulfonyl monocarboxylic acid ester, fatty acid sulfonyl ester, or fatty acid polyoxyethylene ester. The amides include polyoxyethylene alkyl amide, or zwitterionic polyacrylamide. The polyoxyethylene includes polyoxyethylene alkyl amine. The alkyl and/or sulfobetaine include dodecyl ethoxy sulfobetaine, dodecyl dimethyl hydroxypropyl sulfobetaine, dodecyl dimethyl sulfopropyl betaine, tetradecamido propyl hydroxypropyl sulfobetaine, decyl dimethyl hydroxypropyl sulfobetaine, or alkyl dimethyl hydroxypropyl sulfobetaine phosphate. The alkyl and/or hydroxyl amine include octadecyl dihydroxyethyl amine, tetradecyl dihydroxyethyl amine, octadecyl propyl amine, coir amide propyl amine, or lauramide propyl amine.

The organic solvent 11 is an organic solvent that can dissolve with polymethyl methacrylates, methyl methacrylate monomers and organic initiators (including one or more of BPO, AIBN, ABVN), specifically is one of hydrocarbon solvent, ester solvent, ketone solvent, alcohol solvent, ether solvent, and alcohol ether solvent, etc., such as one of n-butyl acetate, methyl isopropyl ketone, xylene, dimethyl ether, toluene, ethylene glycol monobutyl ether, ethyl acetate, methyl ethyl ketone, butanone, methyl isobutyl ketone, methyl acetate, ethyl formate, ethyl benzoate, acetone, cyclohexanone, ethylene glycol monoethyl ether, amyl acetate, and isobutanol. In practice, the organic solvent 11 may also be one of chloroform, tetrahydrofuran, dichloromethane, trichloromethane, dichloroethane, and dioxane.

Optionally, the mass proportion of the infrared absorbent is 10%-60%, the mass proportion of the dispersant is less than or equal to 5%, and the mass proportion of the organic solvent is more than or equal to 30%.

When preparing the infrared absorbent dispersion, the infrared absorbent 12, the dispersant 13 and the organic solvent 11 are mixed at a speed ≤500 rpm for 1-5 min to obtain a premix, and then the premix is grinded and dispersed by Nano dispersion technology such as a planetary ball mill to obtain the infrared absorbent dispersion. The specific process of the dispersion technology by planetary ball mill follows. Specifically, a tank of 250 mL and made of nylon material/volume was used. Three milling balls made of zirconia were selected, which are divided into three diameter grades of large, medium and small between 1-30 mm in diameter, with the mass proportion of the large ball 20%, the medium ball 50% and the small ball 30%, respectively. The mass proportion of the milling balls and the above-mentioned premix is 0.5-2.0. The rotation rate is set at 200-800 rpm, and the grinding time is 30-180 min. After filtering by a 250-600 mesh nylon screen for 2-3 times, an infrared absorbent dispersion was obtained finally.

Firstly, the premix may be formed by simple mixing, for example, stirring at a low speed ≤500 rpm for 1-5 min, so that the infrared absorbent can form a suspension with initial interface wetting in the organic solvent with the help of dispersant, which prevents local adhesion zone from forming in the subsequent grinding and stirring step and avoids low concentration or heterogeneous dispersion for the dispersion. After the premix is formed, Nano dispersion technology such as mechanical dispersion or ultrasonic dispersion is applied to further disperse the infrared absorbent 12. In addition to the dispersion of planetary ball mill, other mechanical dispersion may also be applied, including one of roller grinding, vibrating ball grinding, sanding, colloid grinding, air grading grinding, emulsion dispersion, and non-interventional homogeneous dispersion. The working principle of the non-interventional homogeneous dispersion follows. The material forms a vortex flow and is fully stirred under the combined action of rotation and revolution with adaptive rate, and the bubbles in the material will be extruded and extracted completely with the vacuum system, so as to homogenize the material. Persons ordinarily skilled in the art may select an appropriate Nano dispersion technology according to the actual situation. The homogeneous and stable infrared absorbent dispersion may be formed after being treated by Nano dispersion technology and fully filtered.

The infrared absorbent dispersion as mentioned above is suitable for the preparation of organic glass by pouring process. By the characteristic molecular structure and action of the infrared absorbent dispersion, the infrared absorbent dispersion may undergo free radical copolymerizations with methyl methacrylate monomers, or generate intermolecular forces with polymethyl methacrylates, in such a way, tight bonding between the infrared absorbent/organic glass interface at the molecular scale is formed by means of covalent bonds or intermolecular forces. At the same time, the infrared absorbent may be uniformly or relatively uniformly distributed in the polymethyl methacrylates due to stable suspension of the infrared absorbent in the dispersion and high intermiscibility and compatibility between the dispersion and the matrix material, which endows with organic glass uniform transparency under visible light and uniform blocking effect under infrared light

### Second Embodiment

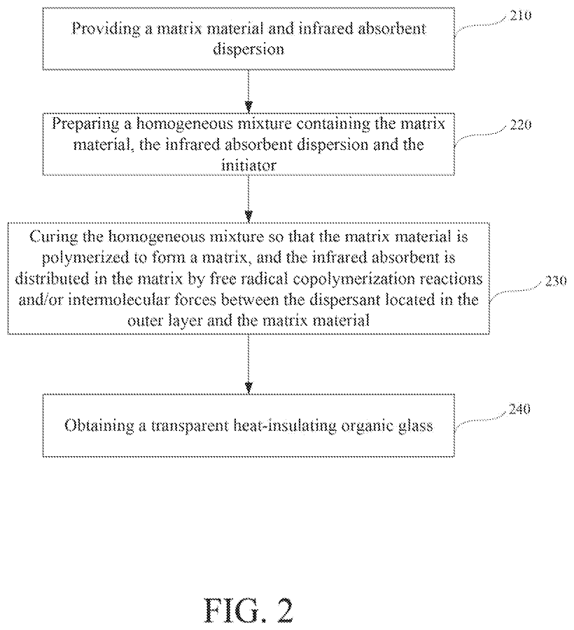

FIG. 2 is flow diagram of the manufacturing method of the transparent heat-insulating organic glass according to the second embodiment. As shown in FIG. 2, the manufacturing method of the transparent heat-insulating organic glass in this embodiment includes:

Step 210, providing a matrix material and infrared absorbent dispersion.

Optionally, the Step 210 includes:
polymerizing methyl methacrylate to form a precursor mixture containing partial polymerized precursors to obtain the matrix material; or
preparing polymethyl methacrylate resin particles into a precursor mixture with methyl methacrylate as solvent to obtain the matrix material.

Specifically, in the precursor mixture containing partial polymerized precursors, the conversion rate of methyl methacrylate is 10%-50%. Radical bulk polymerization reaction occurs between a methyl methacrylate monomer acts with an initiator (including one or several of BPO, AIBN, ABVN) under suitable temperature conditions, to form polymethyl methacrylate solution with methyl methacrylate as solvent with moderate conversion rate. In the precursor mixture with methyl methacrylate as solvent, the mass proportion of the polymethyl methacrylate resin particles is 5%-50%. In the precursor mixture, the content of polymethyl methacrylate is positively correlated with the viscosity. The viscosity becomes lower when the content of polymethyl methacrylate is lower. The thickness of organic glass is adjustable since the precursor mixture with different viscosity may be obtained. The thickness suitable for preparation may be smaller when the viscosity is lower; on the contrary, the thickness suitable for preparation may be larger.

The composition of the infrared absorbent dispersion may be referred to the first embodiment in detail. Optionally, Step 210 further includes:
providing an infrared absorbent, a dispersant and an organic solvent;
mixing the infrared absorbent, the dispersant and the organic solvent at a speed ≤500 rpm for 1-5 min to obtain a premix;
grinding the premix by Nano dispersion technology and then filtering, to obtain the infrared absorbent dispersion.

When preparing the infrared absorbent dispersion, the infrared absorbent, the dispersant and the organic solvent are mixed at a speed ≤500 rpm for 1-5 min to obtain a premix, and then the premix is grinded and dispersed by Nano dispersion technology such as a planetary ball mill to obtain the infrared absorbent dispersion. The specific process of the dispersion technology by planetary ball mill follows. Specifically, a tank of 250 mL and made of nylon material/volume was used. Three milling balls made of zirconia were selected, which are divided into three diameter grades of large, medium and small between 1-30 mm in diameter, with the mass proportion of the large ball 20%, the medium ball 50% and the small ball 30%, respectively. The mass proportion of the milling balls and the above-mentioned premix is 0.5-2.0. The rotation rate is set at 200-600 rpm, and the grinding time is 30-180 min. After filtering by a 250-600 mesh nylon screen for 2-3 times, an infrared absorbent dispersion was obtained finally.

Firstly, the premix may be formed by simple mixing, for example, stirring at a low speed ≤500 rpm for 1-5 min, so that the infrared absorbent can form a suspension with initial interface wetting in the organic solvent with the help of dispersant, which prevents local adhesion zone from forming in the subsequent grinding and stirring step and avoids low concentration or heterogeneous dispersion for the dispersion. After the premix is formed, Nano dispersion technology such as mechanical dispersion or ultrasonic dispersion is applied to further disperse the infrared absorbent 12. In addition to the dispersion by planetary ball mill, other mechanical dispersions may also be applied, including one of roller grinding, vibrating ball grinding, sanding, colloid grinding, air grading grinding, emulsion dispersion, and non-interventional homogeneous dispersion. The working principle of the non-interventional homogeneous dispersion follows. The material forms a vortex flow and is fully stirred under the combined action of rotation and revolution with adaptive rate, and the bubbles in the material will be extruded and extracted completely with the vacuum system, so as to homogenize the material. Persons ordinarily skilled in the art may select an appropriate Nano dispersion technology according to the actual situation. The homogeneous and stable infrared absorbent dispersion may be formed after being treated by Nano dispersion technology and fully filtered.

Step 220, preparing a homogeneous mixture containing the matrix material, the infrared absorbent dispersion and the initiator.

Optionally, the mass proportion of the infrared absorbent dispersion is less than or equal to 5%, the mass proportion of the matrix material is more than or equal to 90%, and the mass proportion of the initiator is less than or equal to 0.5%. The initiator includes one or more of BPO, AIBN and ABVN.

First, the initiator is dissolved in the matrix material (a precursor mixture containing polymethyl methacrylates), and then the infrared absorbent dispersion is added to form a homogeneous system by two steps. With the non-interventional homogeneous dispersion of the Nano dispersion technology, the specific process of each step can be realized by setting reasonable revolution and rotation rate and mutual coordination under the condition of negative pressure, and a bubble-free homogeneous system may be formed under the condition of negative pressure. The precursor mixture containing polymethyl methacrylate has the natural moderate viscosity, which is beneficial to the stable and homogeneous distribution of the infrared absorbent, without the sedimentation problem of the infrared absorbent. The initiator is first dissolved in the polymethyl methacrylate solution, which can ensure the full utilization of the initiator and avoid the formation of unstable coagulation in the infrared absorbent dispersion.

Step 230, curing the homogeneous mixture so that the matrix material is polymerized to form a matrix, and the infrared absorbent is distributed in the matrix by free radical copolymerization reactions and/or intermolecular forces between the dispersant located in the outer layer and the matrix material.

Step 240, obtaining a transparent heat-insulating organic glass.

Optionally, the mold required for the curing of the transparent heat-insulating organic glass is not particularly specified. When curing the homogeneous mixture, water bath at 45-85° C. for 1-5 his carried out first, followed by air bath at 100-130° C. for 1-5 h.

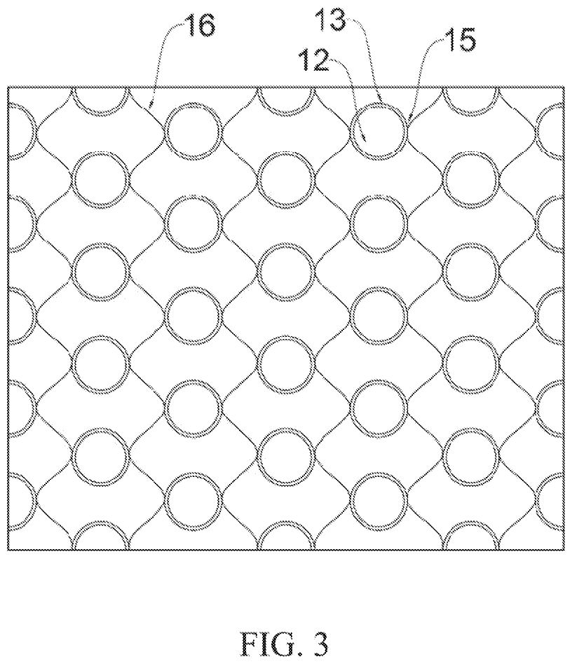

Referring to FIG. 3, the dispersant 13 is distributed in the outer layer of the infrared absorbent 12, by the characteristic molecular structure and action of the dispersant 13, the infrared absorbent 12 may generate free radical copolymerizations with methyl methacrylate monomers and is polymerized into the polymethyl methacrylate chain 16; or, generate intermolecular forces with the polymethyl methacrylate chain 16, in such a way, tight bonding between the infrared absorbent/organic glass interface at the molecular scale is formed by means of covalent bonds or intermolecular forces. At the same time, the infrared absorbent 12 may be uniformly or relatively uniformly distributed in the polymethyl methacrylates due to stable suspension of the infrared absorbent in the dispersion and high intermiscibility and compatibility between the dispersion and the matrix material, which endows with organic glass uniform transparency of visible light and uniform blocking effect of infrared light. Furthermore, the present application solves the dispersion difficulty and interface instability problem of infrared absorbent in the intrinsic oily matrix of organic glass simultaneously, which endows with organic glass visible light transmittance of ≥70% and total solar energy blocking rate of ≥50%, therefore realizes the coordination of transparency and heat insulation function under sunlight irradiation, so that the application of organic glass as the main transparent material can be extended to the novel fields of building heat insulation, near infrared stealth, and plant cultivation, etc., which provides a reliable solution and inspiration for the demand of transparent and heating-insulating organic glass in scientific research and production activities.

Different processes realized by the manufacturing method based on the present embodiment are listed below.

Process 1

Preparation of infrared absorbent dispersion includes the following steps:
A. a step of forming a premix with appropriate proportion of infrared absorbent, dispersant and organic solvent;
B. a step of forming a homogeneous and stable infrared absorbent dispersion.

Specifically, the infrared absorbent was CsxWO₃, with the mass proportion of 30%; the dispersant was polyester modified polydimethylsiloxane, with the mass accounting of 2%; and the organic solvent was n-butyl acetate, with the mass proportion of 68%. In Step A, the premix was formed by simple mixing, for example, stirring at a low speed ≤500 rpm for 1-5 min, so that the infrared absorbent can form a suspension with initial interface wetting in the organic solvent with the help of dispersant, which prevents local adhesion zone from forming in Step B and avoids low concentration or heterogeneous dispersion. In the present embodiment, the premix was formed by stirring at a low speed 300 rpm for 1-5 min.

In Step B, the premix is treated by dispersion technology by a planetary ball mill and fully filtered to obtain a homogeneous and stable infrared absorbent dispersion. Specifically, a tank of 250 mL and made of nylon material/volume was used. Three milling balls made of zirconia were selected, which are divided into three diameter grades of large, medium and small between 1-30 mm in diameter, with the mass proportion of the large ball 20%, the medium ball 50% and the small ball 30%, respectively. The mass proportion of the milling balls and the above-mentioned premix is 0.5-2.0. The rotation rate is set at 200-600 rpm, and the grinding time is 30-180 min. After filtering by a 250-600 mesh nylon screen for 2-3 times, an infrared absorbent dispersion was obtained for further use.

Next, the following steps are carried out:
C. a step of preparing polymethyl methacrylate solution with moderate conversion rate during bulk polymerization of methyl methacrylate;
D. a step of forming a compound ligand with appropriate proportion of the dispersion, polymethyl methacrylate solution and supplementary initiator;
E. a curing step of forming solar heat insulating organic glass.

Specifically, the moderate conversion rate mentioned in Step C may be specifically 10-30%, and 10% was selected in the present process.

The appropriate proportion in Step D represents a proportion by mass, which may be that, dispersion ≤5%, polymethyl methacrylate solution ≥90%, and supplementary initiator ≤0.5%. The supplementary initiator includes one or more of BPO, AIBN and ABVN. In this process, 0.5% modified antibacterial molecules, 99.3% polymethyl methacrylate solution and 0.2% supplementary initiator ABVN were used.

The curing step sequentially includes a water bath at 45-85° C./1-5 h and an air bath at 100-130° C./1-5 h. In this process, water bath at 45-75° C./5 h and air bath at 100-130° C./2 h were used.

Process 2

Compared with Process 1, the difference was that, 1.0% infrared absorbent dispersion, 98.8% polymethyl methacrylate solution and 0.2% supplementary initiator ABVN were used in the process of manufacturing transparent heat-insulating organic glass.

Process 3

Compared with Process 1, the difference was that, 2.0% infrared absorbent dispersion, 97.8% polymethyl methacrylate solution and 0.2% supplementary initiator ABVN were used in the process of manufacturing transparent heat-insulating organic glass.

The following is the performance analysis of the transparent heat-insulating organic glass produced by Processes 1-3.

Sample Preparation

Control group: consistent with the existing manufacturing technology of ordinary organic glass, the specific process will not be repeated, and the sample size is 50 mm×50 mm×4 mm; Process 1-3: the sample size is 50 mm×50 mm×4 mm.

Solar radiation energy is made up of about 7% ultraviolet energy, 43% infrared energy, and 50% visible light energy. A total solar energy blocking rate is the ratio of the blocked solar energy (mainly visible light, infrared light and ultraviolet light) and the total solar energy irradiated on the surface of the object. The meanings for infrared blocking rate, visible light blocking rate, and ultraviolet blocking rate are similar, which will not be repeated. Accordingly, the total solar energy blocking rate was estimated, that is, the total solar energy blocking rate≈infrared blocking rate×43%+visible light blocking rate×50%+ultraviolet blocking rate×7%.

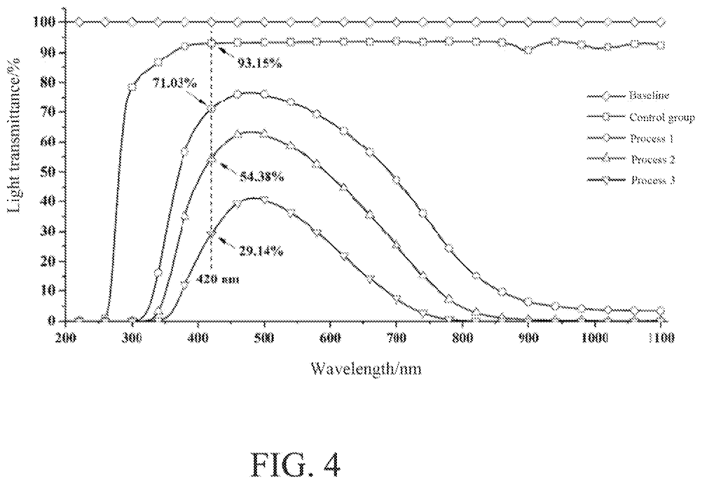

UV-Vis spectral characterization was performed on the above control group, Process 1, Process 2 and Process 3, with the wavelength range of 200-1100 nm and a sampling frequency of once per second. The transmittance of visible light region was tested according to Poly(methyl methacrylate) Cast Sheets (GB/T 7134-2008), and the light transmittance data at the wavelength of 420 nm was obtained. The specific results are shown in FIG. 4, the light transmittance at 420 nm in the control group was 93.15%, and the infrared blocking rate is less than 8%; the visible light transmittance in Processes 1-3 was decreased in turn while the infrared blocking rate was increased in turn, which is consistent with the theoretical result that the proportion of infrared absorbents gradually increases. The infrared blocking rate for the three processes is all greater than 90%, and the visible light transmittance of Process 1 is 71.03%, which may meet the transparency requirements of practical application scenarios; while the visible light transmittance of Process 2 is only 54.38%, which is slightly low. Therefore, Process 1 was taken as an example, the UV-Vis spectral curves of Process 1 and control group (represented by curve functions of f(x) and g(x) respectively) were performed with integral operation with wavelength range as the independent variable interval, and the integral results in the same wavelength range as the baseline (the curve function of baseline is 100%) were performed with division operation, thereby estimating the segmented blocking rates and the total solar energy blocking rate of Process 1 (rounding). The ratio calculation results are shown in Table 1.

TABLE 1
Ratio calculation result

| Wavelength range/nm | Baseline | Control group | Process 1 |
|---|---|---|---|
| [x1, x2] | ∫ₓ₁^{x2} 100% | ∫ₓ₁^{x2} g(x), ∫ₓ₁^{x2} g(x)/∫ₓ₁^{x2} 100% | ∫ₓ₁^{x2} f(x), ∫ₓ₁^{x2} f(x)/∫ₓ₁^{x2} 100% |
| Ultraviolet [190, 380] | 18000 | 8664, 48%, blocking rate 52% | 1709, 10%, blocking rate 90% |
| Visible light [380, 780] | 40000 | 37398, 93%, blocking rate 7% | 24503, 61%, blocking rate 39% |
| Infrared [780, 1100] | 32000 | 29705, 93%, blocking rate 7% | 2416, 8%, blocking rate 92% |

Based on the UV-Vis spectrogram results of the sample of Process 1, the total solar energy blocking rate of the sample of Process 1 was estimated. The total solar energy blocking rate for the sample of Process 1≈infrared blocking rate×43%+visible light blocking rate×50%+ultraviolet blocking rate×7%=92%×43%+39%×50%+90%×7%=39.56% 50%+90%+19.5%+6.3%=65.36%. It can be seen that the transparent heat-insulating organic glass prepared in the present application has good effect of solar energy insulation effect.

The present application also provides a transparent heat-insulating organic glass prepared using the manufacturing method of a transparent heat-insulating organic glass described above.

The present application provides an infrared absorbent dispersion suitable for manufacturing transparent heat-insulating organic glass, a transparent heat-insulating organic glass, and a manufacturing method of a transparent heat-insulating organic glass, and meanwhile provides a method which can synchronously realize the homogeneous dispersion and of the infrared absorbent in the intrinsic oil matrix of the organic glass and the stable and tight bonding at the interface, thereby endowing with the organic glass efficient infrared light blocking effect on the basis of high visible light transmittance. By using Nano dispersion technology to prepare the infrared absorbent oil soluble dispersion suitable for the organic glass system, regulating the complex system with polymethyl methacrylate solution suitable for conversion, and optimizing the curing process, the present application solves the dispersion difficulty and interface instability problem of infrared absorbent in the intrinsic oily matrix of organic glass simultaneously, which endows with organic glass visible light transmittance of 70% and total solar energy blocking rate of 50%, therefore realizes the coordination of transparency and heat insulation function under sunlight irradiation, so that the application of organic glass as the main transparent material can be extended to the novel fields of building heat insulation, near infrared stealth, and plant cultivation, etc., which provides a reliable solution and inspiration for the demand of transparent and heating-insulating organic glass in scientific research and production activities. Taking building heat insulation as an example, the solar heat-insulting organic glass provided by the invention may be widely used in various places required lighting, such as hotels, villas, railway stations, parking sheds, parks, overpasses, airports, shopping malls and hospitals, etc. Compared with the conventional inorganic glass, the organic glass according to the present application has better experiences or more choices in heat insulation, light transmission, lightweight, sound insulation, construction speed, color selection, appearance design, etc.

For the infrared absorbent dispersion of the present application, the dispersant is distributed in the outer layer of the infrared absorbent to form an independent unit dispersed in the organic solvent, and the molecular structure of the dispersant has an active unit capable of generating a free radical copolymerization reaction with a methyl methacrylate monomer and/or a group capable of generating intermolecular forces with polymethyl methacrylate. In the manufacturing method of a transparent heat-insulating organic glass of the present application, the infrared absorbent is distributed in the matrix by free radical copolymerization reactions and/or intermolecular forces between the dispersant located at the outer layer and the matrix material. Due to stable suspension of the infrared absorbent in the dispersion and high intermiscibility and compatibility between the dispersion and the matrix material, the dispersion uniformity of the infrared absorbent in the organic glass is improved. At the same time, by free radical copolymerization reactions and/or intermolecular forces between the dispersant located at the outer layer and the matrix material, the infrared absorbent is distributed in the matrix and tightly bonded with the matrix, which endows with organic glass uniform transparency of visible light and uniform blocking effect of infrared light. Further, the organic glass may be prepared by traditional pouring and curing process with low cost.

The above embodiments are illustrative only for the principle and effect of the present application and are not intended to restrict the present application. Modifications or alterations may be made on the above embodiments by any person skilled in the art, within the spirit and scope of the present application. Therefore, all modifications or alterations made by persons skilled in the art without deviating from the spirit and technical principle revealed in the present application shall be included in the protection scope of the technical solution.

### INDUSTRIAL PRACTICABILITY

For the infrared absorbent dispersion of the present application, the dispersant is distributed in the outer layer of the infrared absorbent to form an independent unit dispersed in the organic solvent, and the molecular structure of the dispersant has an active unit capable of generating a free radical copolymerization reaction with a methyl methacrylate monomer and/or a group capable of generating intermolecular forces with polymethyl methacrylate. In the manufacturing method of a transparent heat-insulating organic glass of the present application, the infrared absorbent is distributed in the matrix by free radical copolymerization reactions and/or intermolecular forces between the dispersant located at the outer layer and the matrix material. Due to stable suspension of the infrared absorbent in the dispersion and high intermiscibility and compatibility between the dispersion and the matrix material, the dispersion uniformity of the infrared absorbent in the organic glass is improved. At the same time, by free radical copolymerization reactions and/or intermolecular forces between the dispersant located at the outer layer and the matrix material, the infrared absorbent is distributed in the matrix and tightly bonded with the matrix, which endows with organic glass uniform transparency of visible light and uniform blocking effect of infrared light. Further, the organic glass may be prepared by traditional pouring and curing process with low cost.

1. An infrared absorbent dispersion, comprising an infrared absorbent, a dispersant and an organic solvent, wherein the dispersant is distributed in an outer layer of the infrared absorbent to form an independent unit dispersed in the organic solvent; molecular structure of the dispersant contains an active unit capable of generating a free radical copolymerization reaction with a methyl methacrylate monomer and/or a group capable of generating intermolecular forces with polymethyl methacrylate; and the organic solvent is an organic solvent that is mutually soluble with the methyl methacrylate monomer and the polymethyl methacrylate.

2. The infrared absorbent dispersion according to claim 1, wherein a mass proportion of the infrared absorbent is 10%-60%, a mass proportion of the dispersant is less than or equal to 5%, and a mass proportion of the organic solvent is more than or equal to 30%.

3. The infrared absorbent dispersion according to claim 1, wherein the infrared absorbent is inorganic powder particles comprising one or more of WO₃, MoO₃, ATO, ITO, BTO, GTO and CsxWO₃, with a particle size range of 5-100 nm.

4. The infrared absorbent dispersion according to claim 1, wherein the dispersant is one or more of silicone modified acrylate, polyester modified dimethylsiloxane containing hydroxy functional groups, polyether modified polydimethylsiloxane, low molecular weight unsaturated acid polycarboxylate polyester containing polysiloxane copolymers, organic salts, esters, amides, polyoxyethylene, alkyl and/or sulfobetaine, and alkyl and/or hydroxy-oxyamine.

5. A manufacturing method of a transparent heat-insulating organic glass, comprising:
a. providing a matrix material and the infrared absorbent dispersion according to claim 1;
b. preparing a homogeneous mixture containing the matrix material, the infrared absorbent dispersion and an initiator;
c. curing the homogeneous mixture so that the matrix material is polymerized to form a matrix, and the infrared absorbent is distributed in the matrix by free radical copolymerization reactions and/or intermolecular forces between the dispersant located at the outer layer and the matrix material;
d. obtaining a transparent heat-insulating organic glass.

6. The manufacturing method of a transparent heat-insulating organic glass according to claim 5, wherein step a comprises:
polymerizing methyl methacrylate to form a precursor mixture containing partial polymerized precursors to obtain the matrix material; or
preparing polymethyl methacrylate resin particles into a precursor mixture with methyl methacrylate as solvent to obtain the matrix material.

7. The manufacturing method of a transparent heat-insulating organic glass according to claim 6, wherein in the precursor mixture containing partial polymerized precursors, a conversion rate of the methyl methacrylate is 10%-50%; or when preparing the precursor mixture with methyl methacrylate as solvent, a mass proportion of the polymethyl methacrylate resin particles is 5%-50%.

8. The manufacturing method of a transparent heat-insulating organic glass according to claim 5, wherein step a comprises:
providing the infrared absorbent, the dispersant and the organic solvent;
mixing the infrared absorbent, the dispersant and the organic solvent at a speed of less than or equal to 500 rpm for 1-5 min to obtain a premix;
treating the premix by Nano dispersion technology and then filtering, to obtain the infrared absorbent dispersion.

9. The manufacturing method of a transparent heat-insulating organic glass according to claim 5, wherein in step b, a mass proportion of the infrared absorbent dispersion is less than or equal to 5%, a mass proportion of the matrix material is more than or equal to 90%, and a mass proportion of the initiator is less than or equal to 0.5%, and the initiator comprises one or more of BPO, AIBN and ABVN.

10. A transparent heat-insulating organic glass, manufactured by the manufacturing method of a transparent heat-insulating organic glass according to claim 5.
